(19) United States
(12) Patent Application Publication
(10) Pub. No.: US 2025/0252345 A1
(43) Pub. Date: Aug. 7, 2025

(54) SYSTEM FOR UNLEARNING DATA WITHIN MACHINE LEARNING-BASED VIRTUAL ASSISTANTS

(71) Applicant: BANK OF AMERICA CORPORATION, Charlotte, NC (US)

(72) Inventors: Ravi Kesani, Hyderabad, Telangana (IN); Sandeep Kumar Chauhan, Hyderabad, Telangana (IN); Iruvanti John Dinakar, Bhadradri Kothagudem, Telangana (IN)

(73) Assignee: BANK OF AMERICA CORPORATION, Charlotte, NC (US)

(21) Appl. No.: 18/435,211

(22) Filed: Feb. 7, 2024

(51) Int. Cl. G06N 20/00

(52) U.S. Cl. CPC G06N 20/00

(57) ABSTRACT

Undesirable data used in the Machine Learning (ML) models of virtual assistants is identified and “unlearned” or otherwise forgotten/erased from the models. Agents/monitors are deployed within virtual assistant services and the ML models themselves, such as the NLP models, that intelligently and continuously crawl the services and the ML models to identify data sets that meet predefined criteria (i.e., unlearning data criteria). The unlearning data identification agents/monitors feed identified data sets to unlearning algorithms which determine unlearning rules applicable to the data sets and subsequently are executed on the ML models to retrain the models to unlearn data related to and included within the identified data sets based on the determined unlearning rules.

### FIELD OF THE INVENTION

The present invention is related generally to Machine Learning (ML) within virtual assistants and, more specifically, and identifying data sets used by a virtual assistant that should be unlearned/forgotten and re-training the virtual so that the data sets are forgotten/unlearned.

### BACKGROUND

Virtual assistants continue to become an integral part of everyday life. A virtual assistant is a computer program or an application, commonly referred to as a “chat bot” or the like, which is designed to perform tasks for an individual or an entity. These tasks can include answering questions, providing information, scheduling appointments/reservations, and the like. Virtual assistants, such as voice response virtual assistants, use artificial intelligence (AI) and Natural Language Processing (NLP) to understand and respond to user inputs/queries. Virtual assistants have been integrated into various computing platforms, such as smart speakers, smartphones, computers, and other digital devices, to help users with a wide range of tasks and inquiries. Examples of virtual assistants include SIRI® from the Apple Corporation of Cupertino, California, ALEXA® from Amazon.com Inc of Seattle, Washington, GOOGLE ASSISTANT from GOOGLE ASSISTANT® from Google LLC of Mountain View, California and the like.

Virtual assistants are trained using a process called supervised learning in the field of Machine Learning (ML). The training process entails collecting a vast corpus of data, including text data, voice data (e.g., conversations) and other inputs that the virtual assistant is expected to process. Human annotators analyze the collected data and label it accordingly. For example, conversational data may be labeled for the intent of the user's query and provide corresponding responses. The labeled data serves as the training set. A neural network architecture, such as the Generative Pre-trained Transformer (GPT) architecture, which understands patterns and relationships in data is selected as the model. The model is trained on annotated/labeled data, during which the model adjusts internal parameters based on the input data and the correct output provided by the annotations. This training process involves feeding the model input data and adjusting the parameters so that the output aligns with the desired results. The trained model is validated on a separate set of data to ensure that the model generalizes to new, unseen inputs. Once the model is trained and validated. The model is deployed as a virtual assistant, capable of understanding and generating human-like responses based on the patterns learned during training.

Virtual assistants continue to improve through use of Attention Modelling (AM) techniques and the like, which allow for larger sized models (i.e., more parameters), larger compute resources (e.g., General Processing Units (GPUs)) for training and an overall increased amount of training data.

Once deployed the virtual assistants learn to comply with the procedures/policies of the virtual assistant provider, which may evolve and change over time to meet the needs and requirements of the provider. Further, over time, the virtual assistants learn preferences/behaviors of the users. As the virtual assistants learn/evolve over-time it is imperative that the virtual assistants mitigate perils around protecting user data and internal and external regulations.

Therefore, a need exists to develop systems, computerized methods, computer program products and the like that will increase the responsibility of the virtual assistants and mitigate perils such as propagation and amplification of unfair bias, decisions based on stale/obsolete data and privacy intrusions stemming from remanence of user data in the models.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention provide for systems, methods, computer program products and the like that “unlearn” or otherwise forget/erase data used in virtual assistants. The invention implements agents/monitors that are deployed within virtual assistant services and, in some embodiments within the ML models themselves, such as the NLP models.

The agents intelligently and continuously crawl the services and, in some instances, the ML models to identify data sets that meet predefined criteria (i.e., unlearning data criteria). These agents/monitors may include, but are not limited to, (i) bias agent(s)/monitor(s) that identify data sets that meet unlearning data criteria related to social identity bias (e.g., ethnicity, length of life or other identifying characteristics, (ii) principled agent(s)/monitor(s) that identify data sets that meet the unlearning data criteria related to principled considerations impacting an entity controlling the virtual assistant (e.g., privacy/security concerns, environmental impact, and the like), (iii) stale data agent(s)/monitor(s) that identify data sets that meet the unlearning data criteria related to at least one of (i) outdated information and (ii) obsolete information and the like.

In accordance with embodiments of the present invention, the unlearning data identification agents/monitors feed identified data sets to effective, efficient and principled unlearning algorithms which determine unlearning rules applicable to the data sets and subsequently are executed on the ML models to retrain the models to unlearn data related to and included within the identified data sets based on the determined unlearning rules.

As a result, the present invention is able to efficiently remove the influence of such data from the virtual assistant such that future responses do not include or are otherwise impacted by the unlearned/forgotten data. In this regard, in specific embodiments of the invention, social identity bias, principled considerations and stale data is removed from the models, such that, responses to user queries do not include or are otherwise impacted by such biases, principled considerations, stale/outdated data or the like.

A system for unlearning data within a virtual assistant defines first embodiments of the invention. The system includes a computing platform which may comprise at least one, and typically more, computing devices. The computing platform includes a memory and one or more computing processor devices in communication with the memory. The memory stores a virtual assistant platform (e.g., a voice assistant or the like) that is executable by at least one of the one or more computing processor devices and includes a plurality for virtual assistant services and first Machine-Learning (ML) model(s) configured to process and respond to user-inputted queries (e.g., Natural Language Processing (NLP models or the like). The system additionally includes an unlearning data identification monitoring sub-system including one or more Artificial-Intelligence (AI)-based unlearning data identification agents. The agents, otherwise referred to as monitors are stored in the memory, executable by at least one of the one or more computing processor devices and configured to continuously crawl, at least, the plurality of virtual assistant services to intelligently identify first data sets that meet previously-learned unlearning data criteria.

The system additionally includes an unlearning data management sub-system including at least one unlearning algorithm having a plurality of unlearning rules. The unlearning algorithm(s) is (are) stored in the memory and executable by at least one of the one or more computing processor devices. The unlearning algorithm(s) is (are) configured to receive, from the AI-based unlearning data identification agents, one or more first data sets that meet the previously-learned unlearning data criteria and determine one or more of the unlearning rules that are applicable to the received one or more first data sets. In response, the unlearning algorithm(s) us (are) configured to retrain the one or more first ML models to unlearn data related to or included within the identified one or more first data sets by applying the one or more determined unlearning rules.

In specific embodiments of the system, the AI-based unlearning data identification agents include a bias data identification agent configured to intelligently identify first data sets that meet the previously-learned unlearning data criteria related to social identity bias (e.g., ethnicity, length of life or the like). In other specific embodiments of the system, the AI-based unlearning data identification agents include a principled data identification agent configured to intelligently identify first data sets that meet the previously-learned unlearning data criteria related to principled considerations impacting an entity controlling the virtual assistant (e.g., privacy/security concerns, environmental impact, and the like). In still further specific embodiments of the system, the AI-based unlearning data identification agents include a stale data identification agent configured to intelligently identify first data sets that meet the previously-learned unlearning data criteria related to at least one of (i) outdated information and (ii) obsolete information.

In other specific embodiments of the system, the AI-based unlearning data identification agents are further configured to continuously crawl the one or more ML models to intelligently identify second data sets that meet previously-learned unlearning data criteria and wherein the at least one unlearning algorithm is further configured to (i) receive, from the one or more ML models, one or more second data sets that meet the previously-learned unlearning data criteria, (ii) determine one or more of the unlearning rules that are applicable to the received one or more second data sets, and (iii) retrain the one or more first ML-models to unlearn data related to or included within the identified one or more second data sets by applying the one or more determined unlearning rules.

In other specific embodiments of the system, the unlearning algorithm(s) comprise(s) second Machine-Learning (ML) model(s) that is (are) trained to re-train the first ML models to unlearn the data related to or included within the identified first data sets by applying the one or more determined unlearning rules.

In still further specific embodiments of the system, the unlearning algorithm is further configured to publish the data related to or included within the identified first data sets to one or more system of records (SORs), wherein the one or more systems of record include at least one of (i) governance SOR, (ii) data library (e.g., NLP library) SOR and (iii) context and intents SOR. In related embodiments of the system, the AI-based unlearning data identification agents are further configured to continuously crawl the one or more SORs to intelligently identify second data sets that meet previously-learned unlearning data criteria. In such embodiments of the system, the unlearning algorithm(s) is (are) further configured to (i) receive, from the one or more SORs, one or more second data sets that meet the previously-learned unlearning data criteria, (ii) determine one or more of the unlearning rules that are applicable to the received one or more second data sets, and (iii) retrain the one or more first ML-models to unlearn data related to or included within the identified one or more second data sets by applying the one or more determined unlearning rules. In further related embodiments of the system, at least one of the SORs are relied upon for training new first ML models included within the virtual assistant platform.

Moreover, in other embodiments of the system, the unlearning algorithm(s) is (are) further configured to (i) receive, from a secondary entity (e.g., data analyst, data identification sub-system/algorithm), one or more second data sets that include data requiring unlearning, (ii) determine one or more of the unlearning rules that are applicable to the identified one or more second data sets, and (iii) retrain the one or more first ML-models to unlearn data related to or included within the identified second data sets by applying the one or more determined unlearning rules.

A computer-implemented method for unlearning data within a virtual assistant defines second embodiments of the invention. The computer-implemented method includes deploying one or more Artificial Intelligence (AI)-based unlearning data identification agents within a plurality of virtual assistant services included in a virtual assistant platform to continuously crawl the plurality of virtual assistant services to intelligently identify first data sets that meet previously-learned unlearning data criteria. The computer-implemented method further includes receiving, at one or more unlearning algorithms that include a plurality of unlearning rules, one or more first data sets from the Al-based unlearning data identification agents that meet the previously-learned unlearning data criteria and determining one or more of the plurality of unlearning rules that are applicable to the received one or more first data sets. The computer implemented method further includes executing the unlearning algorithm(s) to retrain one or more first ML-models included in the virtual assistant platform, which are configured to process and respond to user-inputted queries. Retraining includes unlearning data related to or included within the identified one or more first data sets by applying the one or more determined unlearning rules.

In specific embodiments of the computer-implemented method, deploying the one AI-based unlearning data identification agent(s) further comprises deploying the one or more AI-based unlearning data identification agents including at least one chosen from the group consisting of (i) a bias data identification agent configured to intelligently identify first data sets that meet the previously-learned unlearning data criteria related to social identity bias, (ii) an principled data identification agent configured to intelligently identify first data sets that meet the previously-learned unlearning data criteria related to principled considerations impacting an entity controlling the virtual assistant, and (iii) a stale data identification agent configured to intelligently identify first data sets that meet the previously-learned unlearning data criteria related to at least one of (a) outdated information and (b) obsolete information.

In other specific embodiments of the computer-implemented method, the method includes (i) deploying the AI-based unlearning data identification agent(s) within the first ML models to continuously crawl the one or more first ML models to intelligently identify second data sets that meet previously-learned unlearning data criteria (ii) receiving, at the one or more unlearning algorithms, one or more second data sets from the one or more first ML models that meet the previously-learned unlearning data criteria, (iii) determining one or more of the plurality of unlearning rules that are applicable to the received one or more second data sets, and (iv) retraining the one or more first ML models, wherein retraining includes unlearning data related to or included within the identified one or more second data sets by applying the one or more determined unlearning rules.

In further specific embodiments of the computer-implemented method, the method further includes publishing the data related to or included within the identified first data sets to one or more system of records (SORs) including at least one of (i) governance SOR, (ii) data library SOR and (iii) context and intents SOR. In related embodiments of the computer-implemented method, the method includes (i) deploying the one or more Artificial Intelligence (AI)-based unlearning data identification agents within the one or more SORs to continuously crawl the SORs to intelligently identify first data sets that meet previously-learned unlearning data criteria, (ii) receiving, at the one or more unlearning algorithms, one or more second data sets from the one or more SORs that meet the previously-learned unlearning data criteria, (iii) determining one or more of the plurality of unlearning rules that are applicable to the received one or more second data sets, and (iv) retraining the one or more first ML models, to unlearn/forget data related to or included within the identified one or more second data sets by applying the one or more determined unlearning rules. A computer program product including a non-transitory computer-readable medium defines third embodiments of the invention. The computer-readable medium includes sets of codes for causing one or more computing devices to deploy one or more Artificial Intelligence (AI)-based unlearning data identification agents within a plurality of virtual assistant services included in a virtual assistant platform to continuously crawl the plurality of virtual assistant services to intelligently identify first data sets that meet previously-learned unlearning data criteria. The computer readable medium further includes a set of codes for causing the computing device(s) to receive, at one or more unlearning algorithms that include a plurality of unlearning rules, one or more first data sets from the AI-based unlearning data identification agents that meet the previously-learned unlearning data criteria and determine one or more of the plurality of unlearning rules that are applicable to the received one or more first data sets. Further, the computer readable medium further includes a set of codes for causing the computing device(s) to execute the algorithm(s) to retrain one or more first ML-models included in the virtual assistant platform and configured to process and respond to user-inputted queries, wherein retraining includes unlearning data related to or included within the identified one or more first data sets by applying the one or more determined unlearning rules.

In specific embodiments of the computer program product, the set of codes for causing the computing device(s) to deploy are further configured to cause the computing device(s) to deploy the one or more AI-based unlearning data identification agents including at least one chosen from the group consisting of (i) a bias data identification agent configured to intelligently identify first data sets that meet the previously-learned unlearning data criteria related to social identity bias, (ii) an principled data identification agent configured to intelligently identify first data sets that meet the previously-learned unlearning data criteria related to principled considerations impacting an entity controlling the virtual assistant, and (iii) a stale data identification agent configured to intelligently identify first data sets that meet the previously-learned unlearning data criteria related to at least one of (a) outdated information and (b) obsolete information.

In other specific embodiments of the computer program product, the sets of codes further include sets of codes for causing the one or more computing devices to (i) deploy the one or more Artificial Intelligence (AI)-based unlearning data identification agents within the one or more first ML models to continuously crawl the one or more first ML models to intelligently identify second data sets that meet previously-learned unlearning data criteria, (ii) receive, at one or more unlearning algorithms, one or more second data sets from the one or more first ML models that meet the previously-learned unlearning data criteria, (iii) determine one or more of the plurality of unlearning rules that are applicable to the received one or more first data sets, and (iv) retrain one or more first ML models, wherein retraining includes unlearning data related to or included within the identified one or more second data sets by applying the one or more determined unlearning rules.

In still further specific embodiments of the computer program product, the sets of codes further include a set of codes configured to cause the one or more computing devices to publish the data related to or included within the identified first data sets to one or more system of records (SORs), wherein the one or more systems of record include at least one of (i) governance SOR, (ii) data library SOR and (iii) context and intents SOR. In related embodiments of the computer program product, the sets of codes further include sets of codes for causing the one or more computing devices to (i) deploy the one or more Artificial Intelligence (AI)-based unlearning data identification agents within the one or more SORs to continuously crawl the SORs to intelligently identify first data sets that meet previously-learned unlearning data criteria, (ii) receive, at the one or more unlearning algorithms, one or more second data sets from the one or more SORs that meet the previously-learned unlearning data criteria, (iii) determine one or more of the plurality of unlearning rules that are applicable to the received one or more second data sets and (iv) retrain the one or more first ML models, wherein retraining includes unlearning data related to or included within the identified one or more second data sets by applying the one or more determined unlearning rules.

Thus, according to embodiments of the invention, which will be discussed in greater detail below, the present invention provides for “unlearning” or otherwise forgetting/erasing data undesirable data used in virtual assistants. Agents/monitors are deployed within virtual assistant services and, in some embodiments within the ML models themselves, such as the NLP models, that intelligently and continuously crawl the services and, in some instances, the ML models to identify data sets that meet predefined criteria (i.e., unlearning data criteria). The unlearning data identification agents/monitors feed identified data sets to unlearning algorithms which determine unlearning rules applicable to the data sets and subsequently are executed on the ML models to retrain the models to unlearn data related to and included within the identified data sets based on the determined unlearning rules.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the disclosure in general terms, reference will now be made to the accompanying drawings, wherein:

FIG. 1 is a schematic/block diagram of a system for unlearning data within virtual assistants, in accordance with embodiments of the present invention;

FIG. 2 is a block diagram of examples of unlearning data identification agents, in accordance with embodiments of the present invention;

FIG. 3 is a block diagram of examples of virtual assistant agents which may have unlearning data identification agents deployed therein, in accordance with embodiments of the present invention;

FIG. 4 is a block diagram of a computing platform including an unlearning data identification sub-system having unlearning data identification agents deployed in specified aspects of the virtual assistant, in accordance with embodiments of the present invention;

FIG. 5 is a block diagram of a computing platform including an unlearning data management sub-system having unlearning algorithms configured to retrain the ML models to unlearn data, in accordance with embodiments of the present invention; and

FIG. 6 is a flow diagram of a method for unlearning data in virtual assistants, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as a system, a method, a computer program product or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as JAVA, PERL, SMALLTALK, C++, PYTHON or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or systems. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational events to be performed on the computer or other programmable apparatus to produce a computer implemented process such that the instructions, which execute on the computer or other programmable apparatus, provide events for implementing the functions/acts specified in the flowchart and/or block diagram block or blocks. Alternatively, computer program implemented events or acts may be combined with operator or human implemented events or acts in order to carry out an embodiment of the invention.

As the phrase is used herein, a processor may be “configured to” perform or “configured for” performing a certain function in a variety of ways, including, for example, by having one or more general-purpose circuits perform the function by executing particular computer-executable program code embodied in computer-readable medium, and/or by having one or more application-specific circuits perform the function.

Thus, according to embodiments of the invention, which will be described in more detail below, systems, methods and computer program products are disclosed that that “unlearn” or otherwise forget/erase data used in virtual assistants. The invention implements agents/monitors that are deployed within virtual assistant services and, in some embodiments within the ML models themselves, such as the NLP models. The agents intelligently and continuously crawl the services and, in some instances, the ML models to identify data sets that meet predefined criteria (i.e., unlearning data criteria). These agents/monitors may include, but are not limited to, (i) bias agent(s)/monitor(s) that identify data sets that meet unlearning data criteria related to social identity bias (e.g., ethnicity, length of life or the like), (ii) principled agent(s)/monitor(s) that identify data sets that meet the unlearning data criteria related to principled considerations impacting an entity controlling the virtual assistant (e.g., privacy/security concerns, environmental impact, and the like), (iii) stale data agent(s)/monitor(s) that identify data sets that meet the unlearning data criteria related to at least one of (i) outdated information and (ii) obsolete information and the like.

In accordance with embodiments of the present invention, the unlearning data identification agents/monitors feed identified data sets to effective, efficient and principled unlearning algorithms which determine unlearning rules applicable to the data sets and subsequently are executed on the ML models to retrain the models to unlearn data related to and included within the identified data sets based on the determined unlearning rules.

As a result, the present invention is able to efficiently remove the influence of such data from the virtual assistant such that future responses do not include or are otherwise impacted by the unlearned/forgotten data. In this regard, in specific embodiments of the invention, social identity bias, principled considerations and stale data is removed from the models, such that, responses to user queries do not include or are otherwise impacted by such biases, principled considerations, stale/outdated data or the like.

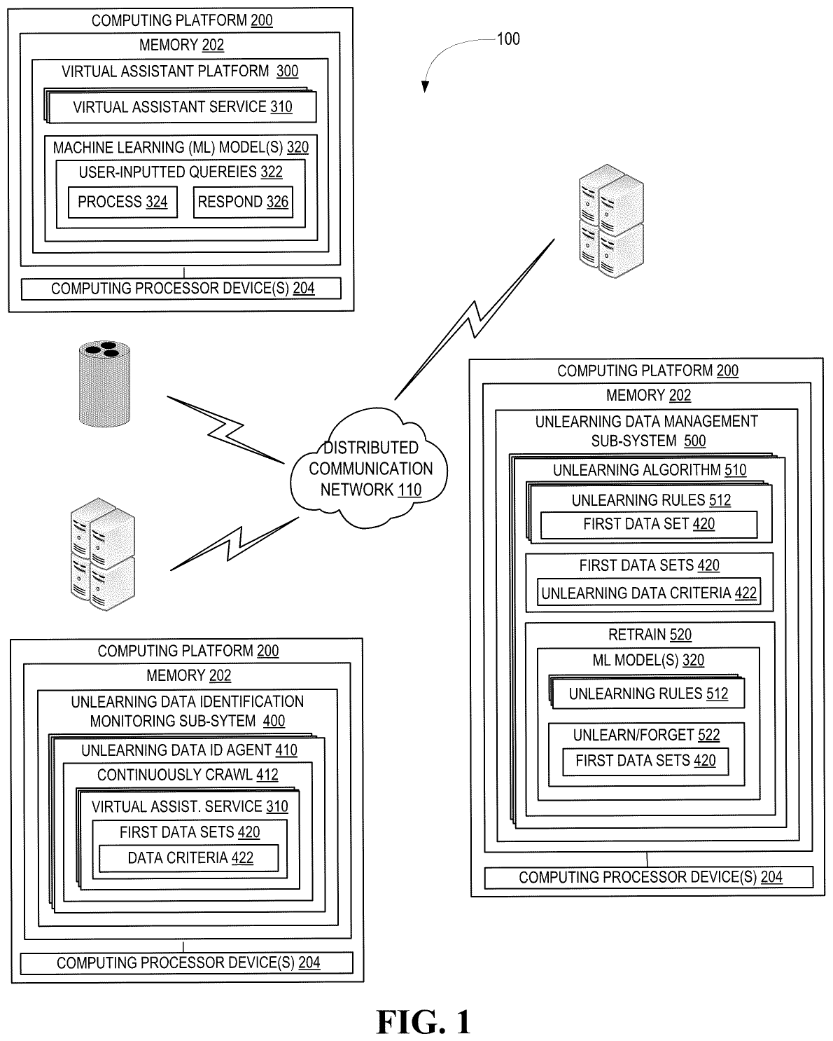

Referring to FIG. 1, a schematic/block diagram is presented of a system 100 for unlearning data in virtual assistants, in accordance with embodiments of the invention. The system 110 may be implemented in conjunction with one or more distributed communication networks 110, such as the Internet, intranet(s), cellular network(s) and the like. System 100 includes a computing platform 200 which may comprise one or more computing devices, such as servers (as shown in FIG. 1), personal computer, mobile devices, wearable devices, smart speakers (as shown in FIG. 1, e.g., chat bot or the like) or the like. The computing platform 200 includes a memory 202 and one, or typically more, computing processor devices 204 in communication with the memory 202. As depicted in FIG. 1, memory 202 and computing processor devices 204 may be disposed within multiple different computing devices/apparatus, which comprise computing platform 200.

Memory 202 of computing platform 200 includes a virtual assistant platform 300 that is executable by at least one of the computing processor devices 204 and which may be disposed within a smart speaker (as shown in FIG. 1, e.g., chat bot), mobile device or embodied within an application or the like. Virtual assistant platform 200 includes a plurality of virtual assistant services 310 and one or more Machine Learning (ML) models 320 that are configured to intelligently process 324 and respond 326 to user-inputted queries 322. The user-inputted queries 322 may be voice commands, text inputs or the like and the responses emanating from the virtual assistant platform 300 may be voice responses, text responses or the like.

Memory 202 of computing platform 200 additionally includes unlearning data identification monitoring sub-system 400 that includes one, and typically more, unlearning data identification agents 410. In specific embodiments of the system, the unlearning data identification agents 410 are Artificial Intelligence (AI)-based agents. Unlearning data identification agents 410 are deployed within, at least, the virtual assistant service(s) 310 and are configured to continuously crawl the virtual assistant service(s) 310 to intelligently identify first data sets 420 that meet predetermined (e.g., previously intelligently learned) unlearning data criteria 422.

Memory 202 of computing platform 200 additionally includes unlearning data management sub-system 500 that includes one or more unlearning algorithms 510 that include a plurality of unlearning rules 512 and are executable by at least one of the computing processor device(s) 204. Unlearning rules 512 define how to go about unlearning data within the ML models 320. For example, whether the data should merely be unlearned/forgotten or whether the data should be unlearned/forgotten and replaced with other data, including the specifics of the other data. Further, unlearning rules 512 may define related data required to be unlearned and/or provide for identifying related data within the models required to be unlearned.

Unlearning algorithm(s) 510 are configured to receive from the unlearning data identification agents 410, first data set(s) 420 that meet the predetermined/previously-learned unlearning data criteria 422 and, in response, determine unlearning rule(s) 512 that are applicable to the first data set(s) 420. In this regard, the type of data (e.g., bias, principled, stale or the like) in the data set may be determinative of the applicable unlearning rules 512 or the applicable unlearning rules 512 may be specific to the data itself (i.e., a specific word, specific phrase or the like). Once the unlearning rules 512 have been determined, unlearning algorithm(s) 510 are configured to re-train 520 the ML model(s) 320 to unlearn 522 data related to or included within the identified first data set(s) 420. Unlearning 522 or forgetting data within the ML models 320 occurs by applying the applicable determined unlearning rules 512 within the ML models 320 to responsively unlearn the data related to or included within the identified first data set(s). It should be noted that re-training 520 as used herein refers to a process consisting solely of unlearning data and does not require full re-training (i.e., starting from the beginning) of the ML model(s) 320.

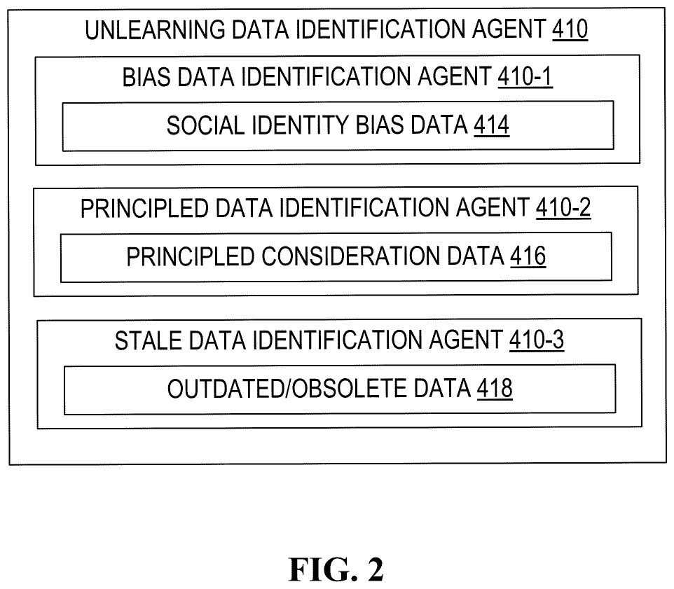

Referring to FIG. 2, a block diagram is depicted that highlights various examples of unlearning data identification agents 410, in accordance with embodiments of the present invention. It should be noted that the unlearning data identification agents 410 described herein are by way of example only and, as such, should not be viewed as limiting. Unlearning data identification agents 410 include bias data identification agent 410-1 that is configured to identify first data sets that meet predetermined (e.g., previously learned) unlearning data criteria related to social identity bias (i.e., social identity bias data 414). Examples of social identity bias data include data that shows a negative, or in some instances positive, bias towards, ethnicity, length of life, disability or the like. Unlearning data identification agents 410 include bias data identification agent 410-1 that is configured to identify data sets that meet predetermined (e.g., previously learned) unlearning data criteria related to social identity bias (i.e., social identity bias data 414). Examples of social identity bias data 414 include data that shows a negative, or in some instances positive, bias towards, ethnicity, length of life, disability or the like.

Further, unlearning data identification agents 410 include principled data identification agent 410-2 that is configured to identify data sets that meet predetermined (e.g., previously learned) unlearning data criteria related to principled considerations impacting the entity controlling the virtual assistant (i.e., principled consideration data 416). Examples of principled consideration data 416 include data that shows a negative, or in some instances positive, bias towards, user data security concerns, environmental impact, and the like. The principled data identification agent 410-2 may operate on peril thresholds, which indicate the tolerance level for peril in regards to unprincipled data.

In addition, unlearning data identification agents 410 include stale data identification agent 410-3 that is configured to identify data sets that meet predetermined (e.g., previously learned) unlearning data criteria related to obsolete and/or outdated data (outdated/obsolete data 818). Examples of outdated/obsolete data 418 include data that has an expiration date that has been exceeded or that has been or should be replaced with more current data. It should be noted that the various types of agents 410 may be deployed on all, in some embodiments of the invention, specific ones of the virtual assistant services.

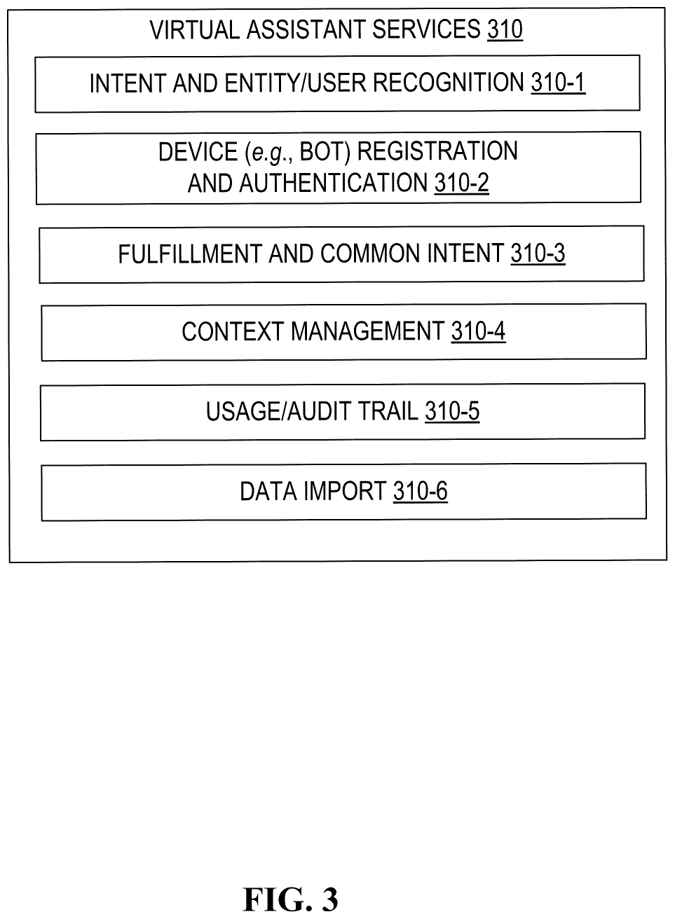

Referring to FIG. 3, a block diagram is depicted that highlights various examples of virtual assistant services 310, in accordance with embodiments of the present invention. It should be noted that the virtual assistant services 310 described herein are by way of example only and, as such, should not be viewed as limiting. Virtual assistant services 310 include intent and entity/user recognition service 310-1 configured to identify/recognize the entity/user and the intent of the entity/user. Further, virtual assistant services 310 include device, such as bot, registration and authentication service 310-2 configured to register and authenticate the user device, such as a chat bot, mobile device or the like. In addition, virtual assistant services 310 include fulfillment and common intents service 310-3 configured to perform the messaging required to send users/entities to other applications or perform other ancillary functions. Additionally, virtual assistant services 310 include context management service 310-4 configured to manage the data that the virtual assistant is assumed to know and usage/audit trail service 310-5 configured for creating an audit trail that indicated how the ML models 320 generate learning or unlearning outputs. Moreover, virtual assistant services 310 may include data import service 310-6 that is configured to manage the import of data into the virtual assistant from external data sources (e.g., other applications, the Internet and the like).

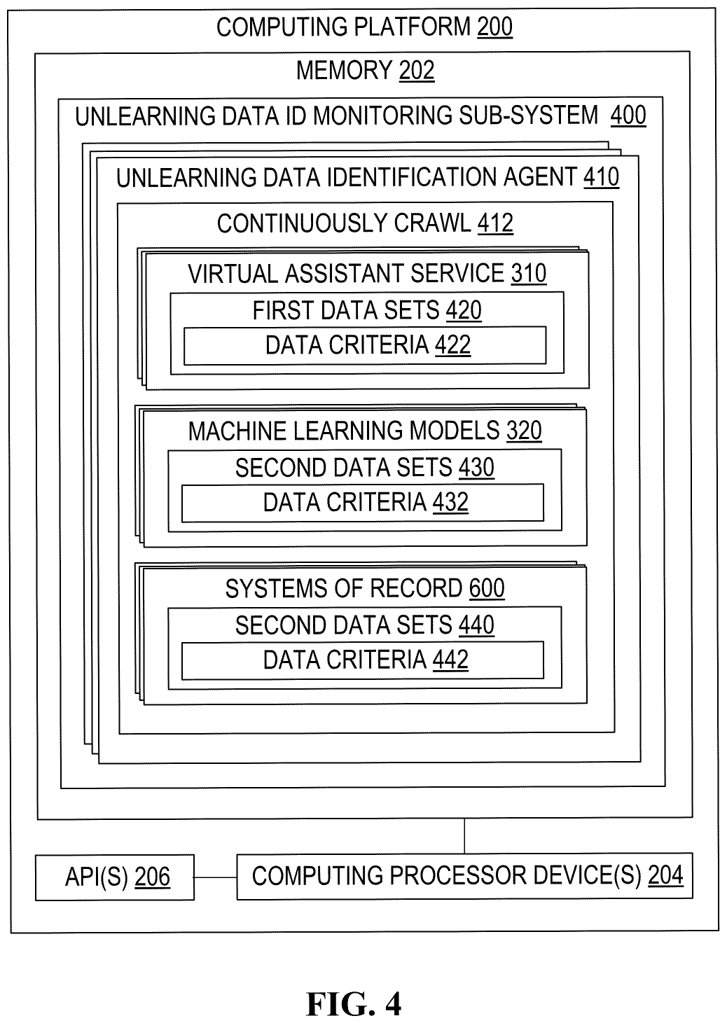

Referring to FIG. 4, a block diagram is presented of the computing platform highlighting various alternate deployments of the unlearning data identification agents 410, in accordance with embodiments of the present invention. As previously discussed in relation to FIG. 1, Computing platform 200 may comprise one or multiple computing devices, such as servers, personal computers, mobile device(s) (e.g., laptop, tablet, smart telephone, smart watch, smart glasses or the like), smart speakers (e.g., chat bots) or the like. As further previously discussed, computing platform 200 includes memory 202, which may comprise volatile and/or non-volatile memory, such as read-only memory (ROM) and/or random-access memory (RAM), EPROM, EEPROM, flash cards, or any memory common to computing platforms. Moreover, memory 202 may comprise cloud storage, such as provided by a cloud storage service and/or a cloud connection service.

Further, computing platform 200 includes one or more computing processor devices 204, which may be an application-specific integrated circuit (“ASIC”), or other chipset, logic circuit, or other data processing device. Computing processor device(s) 204 may execute one or more application programming interface (APIs) 206 that interface with any resident programs, such as unlearning data identification agents 410 or the like, stored in memory 202 of computing platform 200 and any external programs. Computing platform 200 may include various processing sub-systems (not shown in FIG. 4) embodied in hardware, firmware, software, and combinations thereof, that enable the functionality of computing platform 200 and the operability of computing platform 200 on a distributed communication network 110 (shown in FIG. 1), such as the Internet, intranet(s), cellular network(s) and the like. For example, processing sub-systems allow for initiating and maintaining communications and exchanging data with other networked devices. For the disclosed aspects, processing sub-systems of computing platform 200 may include any sub-system used in conjunction with unlearning data identification agents 410 and related tools, routines, sub-routines, applications, sub-applications, sub-modules thereof.

In specific embodiments of the present invention, computing platform 200 additionally includes a communications module (not shown in FIG. 4) embodied in hardware, firmware, software, and combinations thereof, that enables electronic communications between components of computing platform 200 and other networks and network devices. Thus, communication module may include the requisite hardware, firmware, software and/or combinations thereof for establishing and maintaining a network communication connection with one or more devices and/or networks.

As previously discussed in relation to FIG. 1, unlearning data identification monitoring sub-system 400 includes one or more unlearning data identification agents 410. In specific embodiments of the system, the unlearning data identification agents 410 are Artificial Intelligence (AI)-based agents. Unlearning data identification agents 410 are deployed within, at least, the virtual assistant service(s) 310 and are configured to continuously crawl the virtual assistant service(s) 310 to intelligently identify first data sets 420 that meet predetermined (e.g., previously intelligently learned) unlearning data criteria 422. In other embodiments of the invention, unlearning data identification agents 410 are deployed within the machine learning models 320 and are configured to continuously crawl the machine learning models 310 to intelligently identify second data sets 430 that meet predetermined (e.g., previously intelligently learned) unlearning data criteria 432. In still further specific embodiments of the invention unlearning data identification agents 410 are deployed within the systems of record (SORs) 600 (e.g., data dictionary, such as an NLP library, context/classified intents database, governance database) that are associated with and/or relied upon by the virtual assistant platform 300. For example, the SORs may be relied upon for developing and training future ML models 310 used by the virtual assistant platform 300. In such embodiments of the invention, the unlearning data identification agents 410 are configured to continuously crawl the SORs 600 to intelligently identify third data sets 440 that meet predetermined (e.g., previously intelligently learned) unlearning data criteria 442. The unlearning data criteria 422, 432 and 442 used in the virtual assistant services 310, the ML model(s) 320 and the SOR(s) 600 may be the same or different criteria and, as such, the first, second and third data sets 420, 430 and 440 may include the same data or different data.

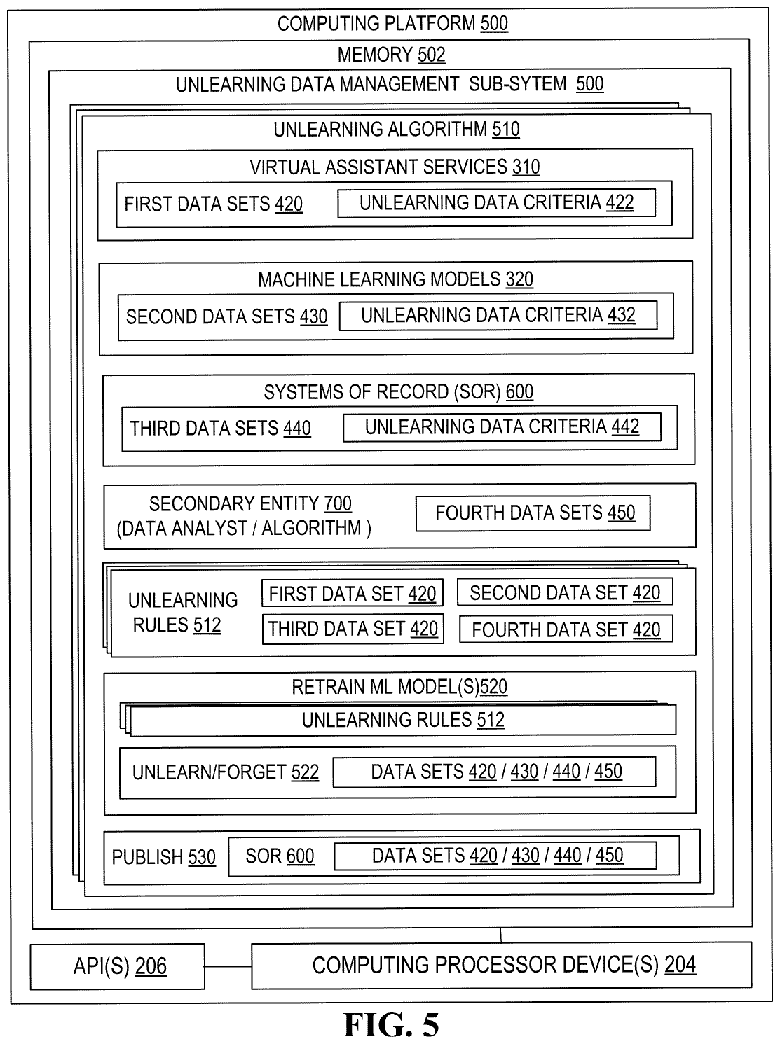

Referring to FIG. 5, a block diagram is presented of the computing platform highlighting various alternate configurations of the unlearning data management sub-system 500, in accordance with embodiments of the present invention. As previously discussed in relation to FIG. 1, memory 202 of computing platform 200 stores unlearning data management sub-system 500 that is executable by one or more of the computing processor devices 804. Unlearning data management sub-system 500 includes one or more unlearning algorithms 510 that include a plurality of unlearning rules 512 and are executable by at least one of the computing processor device(s) 204.

Unlearning algorithm(s) 510 are configured to receive from the unlearning data identification agents 410, first data set(s) 420 that meet the predetermined/previously-learned unlearning data criteria 422. In additional embodiments of the invention, unlearning algorithm(s) 510 are configured to receive from the ML model(s) 320, the Systems of Record(s) 600 and/or secondary entities 700 (e.g., data analysts or other applications/algorithms), second, third and/or fourth data sets 430, 440, 450 that meet the predetermined/previously learned unlearning data criteria 432, 442 or secondary entity criteria. As previously discussed, the unlearning data criteria 422, 432 and 442 and the secondary entity criteria used in the virtual assistant services 310, the ML model(s) 320 and the SOR(s) 600 or by the secondary entities 700 may be the same or different criteria and, as such, the first, second, third and fourth data sets 420, 430, 440, and 450 may include the same data or different data. In response to receiving first, second, third and/or fourth data sets 420, 430, 440 and/or 450, unlearning algorithm(s) 510 are configured to determine unlearning rule(s) 512 that are applicable to the associated data set(s) 420, 430, 440 and/or 450. In this regard, the type of data (e.g., bias, principled, stale or the like) in the data set may be determinative of the applicable unlearning rules 512 or the applicable unlearning rules 512 may be specific to the data itself (i.e., a specific word, specific phrase or the like). Once the unlearning rules 512 have been determined, unlearning algorithm(s) 510 are configured to re-train 520 the ML model(s) 320 to unlearn 522 data related to or included within the identified first, second, third and/or fourth data set(s) 420, 430, 440 and 450. Unlearning 522 or forgetting data within the ML models 320 occurs by applying the applicable determined unlearning rules 512 within the ML models 320 to responsively unlearn the data related to or included within the identified first, second, third and/or fourth data set(s) 420, 430, 440 and/or 450. It should be noted that re-training 520 as used herein refers to a process consisting solely of unlearning data and does not require full re-training (i.e., starting from the beginning) of the ML model(s) 320.

In additional embodiments of the invention, unlearning algorithms 510 are further configured to publish 530 the data related to or included within the identified first, second, third and/or fourth data set(s) 420, 430, 440 and/or 450 and, in some embodiments the applicable rules 512, to one or more Systems of Record (SORs) 600 (e.g., data dictionary, such as an NLP library, context/classified intents database, governance database or the like) that are associated with and/or relied upon by the virtual assistant platform 300. For example, the SORs may be relied upon for developing and training future ML models 310 used by the virtual assistant platform 300.

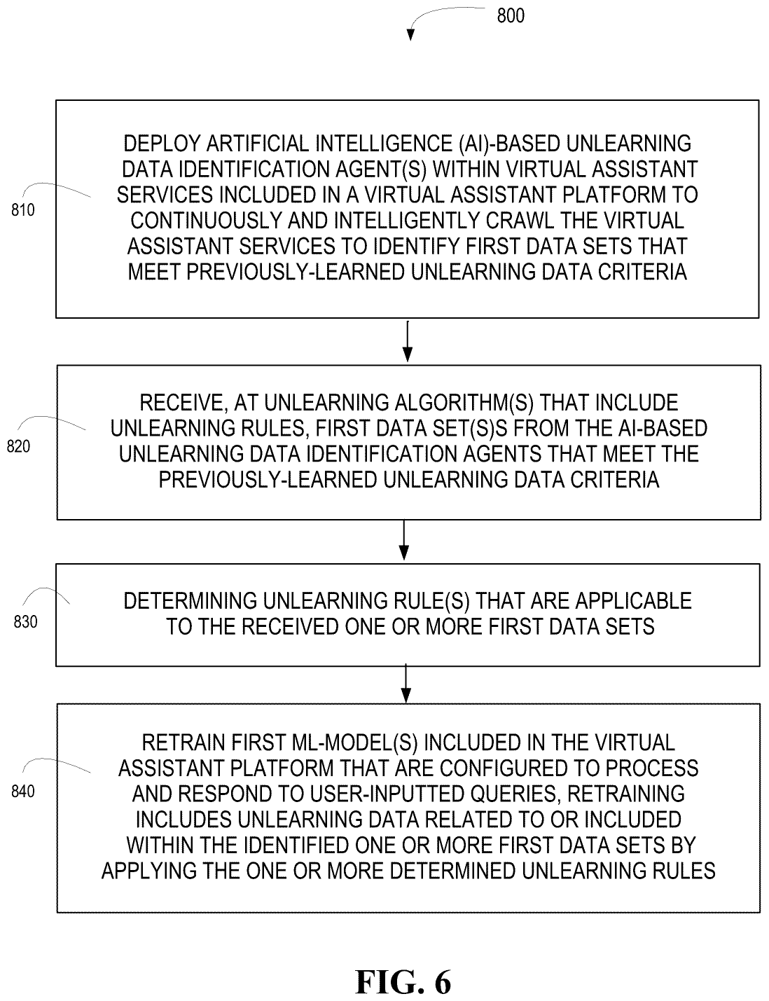

Referring to FIG. 6, a flow diagram is depicted of a method 800 for unlearning data sets within virtual assistants, in accordance with embodiments of the present invention. At Event 810, unlearning data identification agents are deployed within a plurality of virtual assistant services included in a virtual assistant platform so that the agents continuously crawl the plurality of virtual assistant services to intelligently identify data sets that meet previously-learned unlearning data criteria. In alternate embodiments of the method, the unlearning data identification agents are deployed within a ML models included in a virtual assistant platform that used to process and respond to user-inputted queries so that the agents continuously crawl the plurality of ML models to intelligently identify data sets that meet previously-learned unlearning data criteria. In other alternate embodiments of the method, the unlearning data identification agents are deployed within a Systems of Record that are implemented by the virtual assistant platform when generating/training future ML models for the virtual assistant platform. In such alternate embodiments of the method, the agents and the unlearning data criteria may be same agents and/or unlearning data criteria or, in other embodiments the agents deployed in the ML models and/or SORs may different those deployed in the virtual assistant services and/or the unlearning data criteria in the agents may be different for the ML models and/or SORs.

At Event 820, data sets, which meet the previously-learned unlearning data criteria and identified by the unlearning data identification agents are received by unlearning algorithm(s) that include a plurality of unlearning rules and, in response to receiving the data sets, at Event 830, one or more of unlearning rules are determined that are applicable to the data in the data set(s). In specific embodiments of the invention, the type of data (e.g., bias, principled, stale or the like) in the data set or the type of agent from which the data set is received may be determinative of the applicable unlearning rules or the applicable unlearning rules 512 may be specific to the data itself (i.e., a specific word, specific phrase or the like).

In response to determining the applicable unlearning rules, at Event 830, one or more of the ML models included in the virtual assistant platform are re-trained to unlearn/forget data related to or included within the identified data set(s) by applying the one or more determined unlearning rules. Retraining of the ML models as used herein is limited to unlearning the data related to or included within the identified data set(s) and does not re-training of the entire ML model.

Thus, present embodiments of the invention discussed in detail above, the present invention provides for “unlearning” or otherwise forgetting/erasing data undesirable data used in virtual assistants. Agents/monitors are deployed within virtual assistant services and, in some embodiments within the ML models themselves, such as the NLP models, that intelligently and continuously crawl the services and, in some instances, the ML models to identify data sets that meet predefined criteria (i.e., unlearning data criteria). The unlearning data identification agents/monitors feed identified data sets to unlearning algorithms which determine unlearning rules applicable to the data sets and subsequently are executed on the ML models to retrain the models to unlearn data related to and included within the identified data sets based on the determined unlearning rules.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for unlearning data within a virtual assistant, the system comprising:
a computing platform including a memory and one or more computing processor devices in communication with the memory, wherein the memory stores a virtual assistant platform that is executable by at least one of the one or more computing processor devices and includes a plurality for virtual assistant services and one or more first Machine-Learning (ML) models configured to process and respond to user-inputted queries;
an unlearning data identification monitoring sub-system including one or more Artificial-Intelligence (AI)-based unlearning data identification agents stored in the memory, executable by at least one of the one or more computing processor devices and configured to continuously crawl the plurality of virtual assistant services to intelligently identify first data sets that meet previously-learned unlearning data criteria; and
an unlearning data management sub-system including at least one unlearning algorithm including a plurality of unlearning rules, wherein the at least one unlearning algorithm is stored in the memory, executable by at least one of the one or more computing processor devices and configured to:
receive, from the one or more AI-based unlearning data identification agents, one or more first data sets that meet the previously-learned unlearning data criteria,
determine one or more of the unlearning rules that are applicable to the received one or more first data sets, and
retrain the one or more first ML models to unlearn data related to or included within the identified one or more first data sets by applying the one or more determined unlearning rules.

2. The system of claim 1, wherein the one or more AI-based unlearning data identification agents include a bias data identification agent configured to intelligently identify first data sets that meet the previously-learned unlearning data criteria related to social identity bias.

3. The system of claim 1, wherein the one or more AI-based unlearning data identification agents include a principled data identification agent configured to intelligently identify first data sets that meet the previously-learned unlearning data criteria related to principled considerations impacting an entity controlling the virtual assistant.

4. The system of claim 1, wherein the one or more AI-based unlearning data identification agents include a stale data identification agent configured to intelligently identify first data sets that meet the previously-learned unlearning data criteria related to at least one of (i) outdated information and (ii) obsolete information.

5. The system of claim 1, wherein the one or more AI-based unlearning data identification agents are further configured to continuously crawl the one or more ML models to intelligently identify second data sets that meet previously-learned unlearning data criteria and wherein the at least one unlearning algorithm is further configured to (i) receive, from the one or more ML models, one or more second data sets that meet the previously-learned unlearning data criteria, (ii) determine one or more of the unlearning rules that are applicable to the received one or more second data sets, and (iii) retrain the one or more first ML-models to unlearn data related to or included within the identified one or more second data sets by applying the one or more determined unlearning rules.

6. The system of claim 1, wherein the at least one unlearning algorithm comprises one or more second Machine-Learning (ML) models trained to re-train the first ML models to unlearn the data related to or included within the identified first data sets by applying the one or more determined unlearning rules.

7. The system of claim 1, wherein the at least one unlearning algorithm is further configured to publish the data related to or included within the identified first data sets to one or more system of records (SORs), wherein the one or more systems of record include at least one of (i) governance SOR, (ii) data library SOR and (iii) context and intents SOR.

8. The system of claim 7, wherein the one or more AI-based unlearning data identification agents are further configured to continuously crawl the one or more SORs to intelligently identify second data sets that meet previously-learned unlearning data criteria and wherein the at least one unlearning algorithm is further configured to (i) receive, from the one or more SORs, one or more second data sets that meet the previously-learned unlearning data criteria, (ii) determine one or more of the unlearning rules that are applicable to the received one or more second data sets, and (iii) retrain the one or more first ML-models to unlearn data related to or included within the identified one or more second data sets by applying the one or more determined unlearning rules.

9. The system of claim 7, wherein at least one of the one or more SOR are relied upon for training new first ML models included within the virtual assistant platform.

10. The system of claim 1, wherein the at least one unlearning algorithm is further configured to:
receive, from a secondary entity, one or more second data sets that include data requiring unlearning, wherein the secondary entity comprises one chosen from the group consisting of (i) a data analyst and (ii) an unlearning data identification algorithm,
determine one or more of the unlearning rules that are applicable to the identified one or more second data sets, and
retrain the one or more first ML-models to unlearn data related to or included within the identified second data sets by applying the one or more determined unlearning rules.

11. A computer-implemented method for unlearning data within a virtual assistant, the computer-implemented method executed by one or more computing processor devices and comprising:
deploying one or more Artificial Intelligence (AI)-based unlearning data identification agents within a plurality of virtual assistant services included in a virtual assistant platform to continuously crawl the plurality of virtual assistant services to intelligently identify first data sets that meet previously-learned unlearning data criteria;
receiving, at one or more unlearning algorithms that include a plurality of unlearning rules, one or more first data sets from the AI-based unlearning data identification agents that meet the previously-learned unlearning data criteria;
determining one or more of the plurality of unlearning rules that are applicable to the received one or more first data sets; and
retraining one or more first ML-models included in the virtual assistant platform and configured to process and respond to user-inputted queries, wherein retraining includes unlearning data related to or included within the identified one or more first data sets by applying the one or more determined unlearning rules.

12. The computer-implemented method of claim 12, deploying one or more AI-based unlearning data identification agents further comprises deploying the one or more AI-based unlearning data identification agents including at least one chosen from the group consisting of (i) a bias data identification agent configured to intelligently identify first data sets that meet the previously-learned unlearning data criteria related to social identity bias, (ii) an principled data identification agent configured to intelligently identify first data sets that meet the previously-learned unlearning data criteria related to principled considerations impacting an entity controlling the virtual assistant, and (iii) a stale data identification agent configured to intelligently identify first data sets that meet the previously-learned unlearning data criteria related to at least one of (a) outdated information and (b) obsolete information.

13. The computer-implemented method of claim 11, further comprising:
deploying the one or more AI-based unlearning data identification agents within the one or more first ML models to continuously crawl the one or more first ML models to intelligently identify second data sets that meet previously-learned unlearning data criteria;
receiving, at the one or more unlearning algorithms, one or more second data sets from the one or more first ML models that meet the previously-learned unlearning data criteria;
determining one or more of the plurality of unlearning rules that are applicable to the received one or more second data sets; and
retraining the one or more first ML models, wherein retraining includes unlearning data related to or included within the identified one or more second data sets by applying the one or more determined unlearning rules.

14. The computer-implemented method of claim 11, further comprising:
publishing the data related to or included within the identified first data sets to one or more system of records (SORs), wherein the one or more systems of record include at least one of (i) governance SOR, (ii) data library SOR and (iii) context and intents SOR.

15. The computer-implemented method of claim 14, further comprising:
deploying the one or more AI-based unlearning data identification agents within the one or more SORs to continuously crawl the SORs to intelligently identify first data sets that meet previously-learned unlearning data criteria; and
receiving, at the one or more unlearning algorithms, one or more second data sets from the one or more SORs that meet the previously-learned unlearning data criteria;
determining one or more of the plurality of unlearning rules that are applicable to the received one or more second data sets; and
retraining the one or more first ML models, wherein retraining includes unlearning data related to or included within the identified one or more second data sets by applying the one or more determined unlearning rules.

16. A computer program product comprising:
a non-transitory computer-readable medium comprising sets of codes for causing one or more computing devices to:
deploy one or more Artificial Intelligence (AI)-based unlearning data identification agents within a plurality of virtual assistant services included in a virtual assistant platform to continuously crawl the plurality of virtual assistant services to intelligently identify first data sets that meet previously-learned unlearning data criteria;
receive, at one or more unlearning algorithms that include a plurality of unlearning rules, one or more first data sets from the AI-based unlearning data identification agents that meet the previously-learned unlearning data criteria;
determine one or more of the plurality of unlearning rules that are applicable to the received one or more first data sets; and
retrain one or more first ML-models included in the virtual assistant platform and configured to process and respond to user-inputted queries, wherein retraining includes unlearning data related to or included within the identified one or more first data sets by applying the one or more determined unlearning rules.

17. The computer program product of claim 16, wherein the set of codes for causing the one or more computing devices to deploy are further configured to cause the one or more computing devices to deploy the one or more AI-based unlearning data identification agents including at least one chosen from the group consisting of (i) a bias data identification agent configured to intelligently identify first data sets that meet the previously-learned unlearning data criteria related to social identity bias, (ii) an principled data identification agent configured to intelligently identify first data sets that meet the previously-learned unlearning data criteria related to principled considerations impacting an entity controlling the virtual assistant, and (iii) a stale data identification agent configured to intelligently identify first data sets that meet the previously-learned unlearning data criteria related to at least one of (a) outdated information and (b) obsolete information.

18. The computer program product of claim 16, wherein the sets of codes further include sets of codes for causing the one or more computing devices to:
deploy the one or more AI-based unlearning data identification agents within the one or more first ML models to continuously crawl the one or more first ML models to intelligently identify second data sets that meet previously-learned unlearning data criteria;
receive, at one or more unlearning algorithms, one or more second data sets from the one or more first ML models that meet the previously-learned unlearning data criteria;
determine one or more of the plurality of unlearning rules that are applicable to the received one or more first data sets; and
retrain one or more first ML models, wherein retraining includes unlearning data related to or included within the identified one or more second data sets by applying the one or more determined unlearning rules.

19. The computer program product of claim 16, wherein the sets of codes further comprise a set of codes configured to cause the one or more computing devices to publish the data related to or included within the identified first data sets to one or more system of records (SORs), wherein the one or more systems of record include at least one of (i) governance SOR, (ii) data library SOR and (iii) context and intents SOR.

20. The computer program product of claim 19, wherein the sets of codes further include sets of codes for causing the one or more computing devices to:
deploy the one or more AI-based unlearning data identification agents within the one or more SORs to continuously crawl the SORs to intelligently identify first data sets that meet previously-learned unlearning data criteria;
receive, at the one or more unlearning algorithms, one or more second data sets from the one or more SORs that meet the previously-learned unlearning data criteria;
determine one or more of the plurality of unlearning rules that are applicable to the received one or more second data sets; and
retrain the one or more first ML models, wherein retraining includes unlearning data related to or included within the identified one or more second data sets by applying the one or more determined unlearning rules.
